(19) United States
(12) Patent Application Publication
(10) Pub. No.: US 2012/0181168 A1
(43) Pub. Date: Jul. 19, 2012

(54) APPARATUS FOR PRODUCING GASEOUS HYDROGEN AND ENERGY GENERATION SYSTEM UTILISING SUCH APPARATUS

(75) Inventors: Francesco Gargiuolo, Milano (IT); Gabriele Rossato, Valdagno (VI) (IT); Davide Sala, Arcore (MB) (IT); Giovanni Sala, Vimercate (MB) (IT); Maurizio Egidio Brioschi, Vimercate (MB) (IT); Alberto Limonta, Vimercate (MB) (IT)

(73) Assignee: Sonolis S.r.l., Vimercate (IT)

(21) Appl. No.: 13/384,524

(22) PCT Filed: Jun. 25, 2010
(86) PCT No.: PCT/EP2010/059066

§ 371 Date: Mar. 28, 2012

(30) Foreign Application Priority Data
Jul. 14, 2009 (IT) MI2009A001249

(51) Int. Cl. C25B 9/00; C25B 1/04

(52) U.S. Cl. 204/273

(57) ABSTRACT

An apparatus is described for producing gaseous hydrogen, including: a container provided with an input for water; an acoustic-wave generator suitable for inducing sonolysis in the water introduced in the container; an electromagnetic radiation source configured to induce photolysis in the water introduced in the container; a device adapted to induce electrolysis and arranged subsequent to the acoustic-wave generator and at the source of the electromagnetic radiation.

### TECHNICAL FIELD OF THE INVENTION

The present invention refers to techniques for producing gaseous hydrogen, and particularly for producing hydrogen and oxygen from water. In particular, but not limitedly, the present invention refers to the production of gaseous hydrogen to employ as a fuel.

### KNOWN ART

The production of gaseous hydrogen starting from water, in order to obtain a fuel, appears to be an extremely interesting opportunity in the view of the great availability of water as compared with other types of fuel.

The electrolysis of water results the most common technique for the separation of hydrogen from oxygen. Nevertheless, the high electrical power required by electrolysis has entailed that other production techniques of hydrogen be looked for.

With regard to this, the document of Fausto Elisei et al. “Production of hydrogen from water by photolysis assisted by innovative photo-catalysts”, (Eighth National Congress CIRIAF—Acts (Perugia 4-5 Apr. 2008) describes the use of a technique based on the photolysis and also refers to an experimental sonolysis equipment.

### BRIEF SUMMARY OF THE INVENTION

The Applicant has observed that the production modes of gaseous hydrogen in the known art are not satisfactory, both in terms of efficiency and in terms of practical feasibility of a corresponding apparatus.

The aim of the present invention is to propose an apparatus for producing gaseous hydrogen from water, alternative to those of the known art, and which for instance overcomes the limitations of the presently known techniques.

Scope of the present invention is therefore an apparatus for producing gaseous hydrogen from water as described in Claim 1 and from its preferred embodiments described in the dependent Claims 2-8.

Scope of the invention is also an energy generation system as defined in Claim 9 and one of its particular embodiments described in Claim 10.

### BRIEF DESCRIPTION OF THE DRAWINGS

Further characteristics and advantages of the invention will result from the following description of a preferred embodiment and its variations, given in an exemplifying way with reference to the appended drawings, in which:

FIG. 1 shows a cross-section, according to a longitudinal plane, of a first stage of an example of an apparatus for producing gaseous hydrogen;

FIG. 2 shows a cross-section, according to a longitudinal plane, of an example of a second stage of said apparatus for producing gaseous hydrogen;

FIG. 3 shows schematically an energy generation system, employing said apparatus for producing hydrogen;

### DETAILED DESCRIPTION

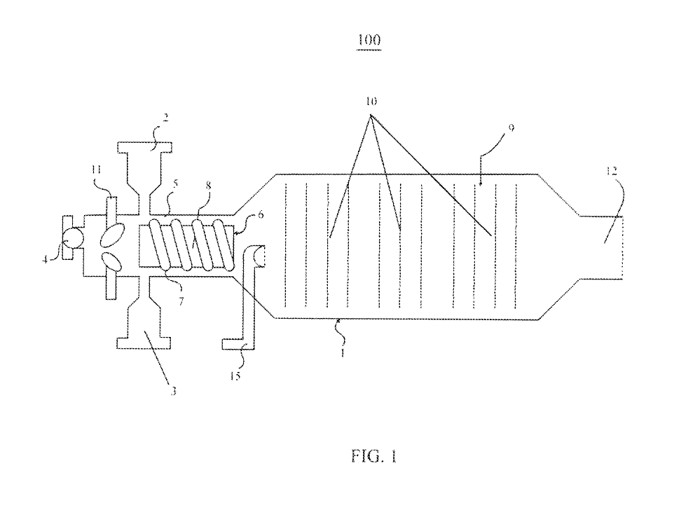

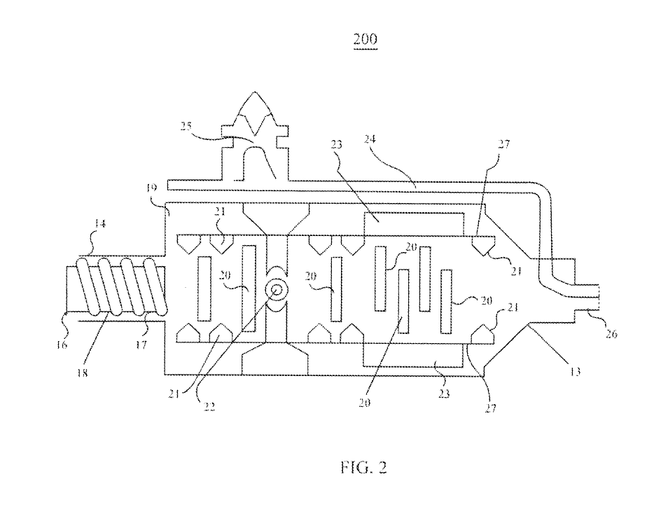

FIGS. 1 and 2 show, respectively and in cross-section, a first stage 100 and a second stage 200 of an apparatus or reactor for producing gaseous hydrogen, realized according to a particular embodiment of the invention.

The first stage 100 comprises a container 1 provided with one or more inputs for water. For instance, the container 1 is made of steel and particularly of AISI 361 L steel and can have a thickness of one millimetre. The water inputs are realized, preferably, by a first group of electro-injectors 2, and optionally by a second group of electro-injectors 3. Such electro-injectors are advantageously of the low pressure type, and provide for the atomization of the water at the inlet on a plurality of jets (for instance, four jets). According to a particular example, the inlet pressure varies between 1 Bar and 5 Bar. The first group of electro-injectors 2 is controlled in a synchronous way with respect to the second group of electro-injectors 3 by an electronic control unit (not shown) which also provides for the cyclic regulation of the injection times.

The first stage 100 is also provided, at a first extreme, with an acoustic-wave generator 4 suitable for inducing acoustic waves in the water which comes out in an atomized form from the electro-injector groups 2 and 3, to produce sonolysis. In particular, the acoustic-wave generator 4 has the shape of an ultrasonic transducer.

According to an example, such ultrasonic transducer 4 comprises nine circular piezoelectric actuators of a diameter comprised between 5 and 45 millimetres in a SONOX P4 or PZT ceramic with an atomizing capacity comprised between 500 ml/h and 2000 ml/h, controlled with a power comprised between 2 and 50 Watt and modulated with a frequency comprised between 15 kHz and 35 kHz. It should be noted that the ultrasonic transducer is capable of generating a phenomenon of water cavitation, by transforming it in “cold” steam with running temperatures comprised between 30 and 80° C.

According to the example shown in FIG. 1, in a peripheral chamber 5 (of tubular shape) of the container 1 a heater 6 is included, as in particular an induction heater, comprising an electric coil 7 (for instance made of copper) wound on a core 8. The induction heater 6 is capable to work at a frequency comprised between 100 kHz and 260 kHz on a core 8 made of soft iron which heats by an inductive effect at 700-800° C. consuming 400/500 Watt. The heater 6 has the task to vaporize the water and transform it in dry steam.

According to the embodiment shown in FIG. 1, an electromagnetic radiation source 11, configured to cause photolysis, is disposed inside the peripheral chamber 5 proximate to the ultrasonic transducer 4.

The electromagnetic radiation source 11 comprises, advantageously, a laser, for instance a solid-state laser with an employed power between 5 mW and 200 mW and an emission wavelength comprised between 200 nm and 880 nm, and which works also in the visible field.

A central region of the container 1 is provided with an electrolytic generation device 9 (i.e. a device suitable to cause electrolysis). Such device 9 is, advantageously, highly efficient and comprises a plurality of electrolytic cells 10, for instance at high voltage (HT), which cause electrolysis in the steam which passes through them in expansion and acceleration. According to a preferred case, such electrolytic cells 10 are made of nickel and tungsten and are formed by a plurality of reticular meshes made of nickel, tungsten carbide and tungsten. The electrolytic cells 10 are fed for example by a continuous voltage varying from 50 V to a maximum of 4000 V. The electrolytic generation device 9 contributes to the transformation of steam in a HHO mixture (i.e. Brown gas) and to the creation of ionized steam.

Preferably, the first stage 100 is also provided with a recovery duct 15 which opens to the inside of the container 1, such as for example, an AISI 316 L steel tube, controlled by a proportional valve (not shown) for the recovery of discharge/unburnt gases of an engine and subsequently used for the stoichiometric enrichment and the preheating of the grids 10. The first outlet 12, which is fitted to the second stage 200, provides that the gaseous mixture HHO and the ionized steam formed in the first stage 100 have access to the second stage 200.

The second stage 200 (FIG. 2) comprises a respective container 13, for example analogous (also for the materials) to the container 1 described previously. An inlet mouth 14 of the second stage 200 is fitted to the first outlet 12 of the first stage 100.

Advantageously, in the inlet mouth 14 a further heater 16 is provided, comprising for example an induction heater, provided with a respective core 17 and a respective coil 18. According to an example, the induction heater 16 works at a frequency comprised between 100 kHz and 260 kHz on a soft iron core 17, which heats by an inductive effect at 200-400° C. by consuming 200 Watt. The task of this heater 16 is to heat the gas after the electrolytic cells 10 and bring it back to temperature.

Inside a chamber 19 of the second stage 200 a plurality of flow separating elements 20 (for example AISI 316 L steel bars) built in order to suitably channel the gas.

At the edges of the chamber 19, a plurality of electromagnetic radiation sources is fixed, comprising, according to the example, discharge lamps 22 and/or at least one LED device 21. The discharge lamps 22 are for instance discharge bulbs working at a frequency varying between 200 and 600 Hz with a wavelength comprised between 200 and 680 nm, piloted with a power of 50 Watt. For example, the LED 21 is an UV (ultraviolet) device with an emission at 250-400 nm starting from 60 mV. The flow separating elements 20 force the gas to pass by proximate to the radiation sources 21 and 22.

According to a preferred embodiment, the second stage 200 is also provided with a magnetic polarizing/separating device. According to a particular example, such magnetic polarizing/separating device comprises two facing magnets 23 (N and S) (for example with a Ni—Cu—Ni alloy) able to deliver a magnetic energy of 40 N and an attraction power of 100 Kg. To these magnets 23 are linked field diffusers 27, made for instance of a magnetic steel (for instance, of AISI 314 L steel).

According to a particular example, the second stage 200 is also provided with an intake conduit 24 for suction from the outside of an ethylic comburent, gaseous comburent or ionized vapour to be fed to an outlet 26 and to be used for the starting of the engine, to which the production apparatus of gaseous hydrogen and the stoichiometric maintenance/enrichment have to be connected, until reaching the running temperatures of the engine itself.

The intake duct 24 is operatively associated with a ionizing plasma generator 25 which allows the vapour or the comburent passing through the intake conduit 24 to be ionized. The plasma generator 25 permits to ionize the gaseous/liquid fuel, with a voltage of approx. 20000 V at a negative polarity and with a frequency working between 3000 Hz and 19000 Hz.

The second stage 200 is also provided with the outlet 26 for delivering the hydrogen present in the Brown HHO gas and a gas or hybrid fuel to the engine. In some applications, ethylic alcohol in mixture with ionized vapour or in certain cases if present Propane Butane or Methane Gas could be used.

In operation, the atomized water is introduced by means of the electro-injector groups 2 and 3 to the inside of the container 1 of the first stage 100. The ultrasonic transducer 4 is actuated in order to generate acoustic waves by causing in the water a phenomenon of oscillating cavitation. It could be noted that the vibrations transmitted by the ultrasonic transducer 4 cause in the water molecule phenomena of stretching, planar deformation and internal rotation. The atomized water, thanks to the oscillating cavitation, is subjected to a first action of sonolysis, causing the formation of hydrogen and in particular of Brown gas (HHO) at a low temperature.

The Brown gas (also called “oxy-hydrogen”) is namely a mixture of hydrogen and oxygen gas typically in the atomic ratio of 2:1, the same as the water.

With reference to the combustion, the Brown gas utilizes the atoms and not the molecules, and the flame produced from them in case of combustion is able to atomize the substances coming in front of it, as it interferes with the substance of the object it is treating. Even with the development of a heat of 130° C., the Brawn gas is able to atomize the tungsten which melts approx. at 6000° C., does no emit harmful radiations and its flame can be looked at without protective masks; it is odourless and is not harmful when inhaled, and does not consume completely the oxygen proximate to the flame, as it derives just from this. The oxy-hydrogen burns (transforming itself in an aqueous steam and releasing the energy that sustains the reaction) when it is brought to its self-ignition temperature.

This steam residing in the peripheral chamber 5 is also interested by the emissions of the laser 11, which thanks to a photolysis effect, further increases the production of hydrogen and in particular of Brown gas.

The gas mixed with steam is then subjected to a heating, thanks to a heat exchange with the core 8, which is warmed by the coil 7 by reaching for instance a temperature of approx. 700-800° C. According to an example, this heating contributes to the creation of hydrogen and Brown gas for a pyrolysis effect. The gaseous expansion which is created tanks to such a heating permits to the treated fluid to reach the region in which the grids 10 are present.

The grids 10 are preheated up to a suitable temperature by the exhaust gas coming from the engine and taken in inside the container 1 by means of the recovery tube 15.

The potential difference (raising towards the first outlet 12) applied to the grids 10 causes electric discharges which cause a further separation of the hydrogen (electrolysis, in this case) in the treated fluid. For example, the potential difference varies longitudinally between 50 V and 4000 V in order to compensate the lower conductivity of the fluid in proximity of the first outlet 12. The grids also contribute to accelerate the gas (HHO and steam) passing through them.

The treated fluid reaches then the first outlet and enters in the second stage 200. The second stage 200 has the task of keeping the HHO gas separated and stored. The further induction heater 16 provides to increase the temperature of the fluid present in the intake mouth 14, causing, preferably, pyrolysis. By photo-pyrolysis inside the chamber 19, the LEDs 21 and the discharge lamp 22 (which emits, for instance, a light with a power of 50 W with an internal temperature of 1200° C.) act on the fluid concurring to maintain it in the form of a Brown gas.

According to another preferred embodiment, the discharge lamp 22 emits at a wavelength comprised between 220 nm and 550 nm, and more preferably, such lamp emits at a wavelength comprised between 240 nm and 280 nm. The best results have been achieved for emission wavelengths of approx. 260 nm.

The magnetic separators 23 maintain the oxygen separated from the hydrogen and the Brown gas is enriched with ionized vapour thanks to the influence of the plasma generator 25 and of the intake tube 24. The plasma generator 25 causes a plasma process at high voltage (HT), and, for instance, it works at a frequency comprised between 3 kHz and 19 kHz at a negative polarization from 20000 V. The Brown gas so obtained is a ionized hydric gas suitable to be supplied to an engine burner.

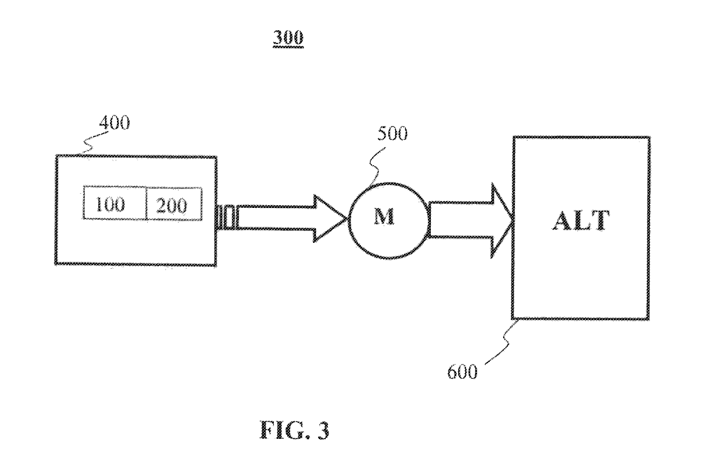

FIG. 3 shows by functional blocks a generation system of electric power 300 comprising the apparatus for producing gaseous hydrogen 400 (REACT) described above, an engine 500 (M) capable of producing a power output connected to an alternator 600 (ALT). The engine 500 is for instance of a Wankel cycle or turbine type with a produced energy, for instance between 5 and 30 kW/h.

The apparatus for producing gaseous hydrogen 400 supplies the fuel (supporter of combustion and fuel) to the engine 550 which, by making use of a burner, produce in a way evident to an expert in the field an output force which transmitted to the alternator 600 permits to generate electric energy (for instance, up to 5 kW/h).

This described example is suitable for generation energy in the domestic field, as, for instance the generation of electric current for supplying the domestic network and the generation of heat for the domestic heating. Nevertheless, the apparatus for generating gaseous hydrogen 400 conforming with the teachings of the invention can be used for thermodynamic engines, cogenerators, turbines, burners or other users.

The described apparatus for producing hydrogen is particularly advantageous. The combined action of sonolysis, photolysis and electrolysis results to be extremely efficient. Furthermore, the action of electrolysis on the steam and not, as it occurs traditionally, on the water in the liquid state brings an important efficiency of the production of Brown gas as the Applicant could evaluate experimentally.

The maintenance of the Brown gas in a form separated from the water, made in the second stage 200 by the combined action of heating (photo-pyrolysis), electromagnetic radiation and magnetic field has shown to be particularly advantageous.

It was determined experimentally that after many days from its production the Brown gas obtained has not recombined itself. Furthermore, the possibility of adding a supporter of combustion by the action of the plasma generator 25 makes the apparatus for producing hydrogen immediately usable (on demand) for feeding a fuel to an engine. The fuel obtainable with the described apparatus results to be suitable for engines actually in use.

1. A gaseous hydrogen producing apparatus, comprising:
a container provided with an input for water;
an acoustic-wave generator structured to induce sonolysis in the water introduced in the container;
an electromagnetic radiation source configured to induce photolysis in the water introduced in the container;
a device adapted to induce electrolysis in the water introduced in the container;
an output for hydrogen in gaseous state.

2. The apparatus according to claim 1, also comprising a first heater structured to vaporize the water that is introduced in the container to provide corresponding vapour; said device for inducing electrolysis, being arranged as to induce electrolysis on said vapour.

3. The apparatus according to claim 2, wherein said first heater is structured to induce pyrolysis, and wherein the acoustic-wave generator, the electromagnetic radiation source, the device for inducing electrolysis and the heater being configured for the production of at least one of the following gases in addition to hydrogen and starting from water: Brown gas, ionized water vapour.

4. The apparatus according claim 1, also including a chamber housing a fluid resulting from the electrolysis including hydrogen and at least one among Brown gas and ionized water vapour; said chamber comprising means to keep the Brown gas and the hydrogen in a separate form.

5. The apparatus according to claim 4, wherein said means for keeping the Brown gas and the hydrogen in a separate form includes:
a second heater of inductive type;
additional electromagnetic radiation sources;
separator elements for channeling the Brown gas and bringing the Brown gas closer to said additional radiation sources.

6. The apparatus according to claim 5, wherein said means for keeping the Brown gas in a separate form includes:
at least one magnetic separator structured to generate a magnetic field in said chamber such as to keep the oxygen separated from the hydrogen and the Brown gas.

7. The apparatus according to claim 5, wherein:
said acoustic-wave generator includes an ultrasound transducer with piezoelectric actuators;
said electromagnetic radiation source includes a laser device;
said device for inducing electrolysis includes a plurality of grids to which a difference in electric voltage can be applied; and
said first and second heaters respectively include an induction winding associated with a respective core to be heated.

8. The apparatus according to claim 3, also comprising:
a suction conduit of an ethylic, comburent, gaseous comburent or ionized vapour;
a plasma generator operatively associated with the suction conduit, which allows the vapour or the comburent to be ionized.

9. A system for energy generation, comprising:
an apparatus structured to produce gaseous hydrogen comprising:
a container provided with an input for water;
an acoustic-wave generator structured to induce sonolysis in the water introduced in the container;
an electromagnetic radiation source configured to induce photolysis in the water introduced in the container;
a device adapted to induce electrolyis in the water introduced in the container;
an output for hydrogen in the gaseous state;
an apparatus structured to utilize said gaseous hydrogen to produce energy;

10. A system according to claim 9, wherein said apparatus structured to utilize said gaseous hydrogen includes at least one of the following devices: a motor, a turbine for motor energy generation, a thermodynamic motor, a cogenerator, a gas burner.

11. The apparatus according to claim 1, wherein the device adapted to induce electrolysis is and arranged subsequent to the acoustic-wave generator and the source of the electromagnetic radiation.
